(19) United States
(12) Patent Application Publication
(10) Pub. No.: US 2005/0031796 A1
(43) Pub. Date: Feb. 10, 2005

(54) Method and apparatus for controlling spatial distribution of RF power and plasma density

(75) Inventors: Sunny Wu, Douliou City (TW); Bing-Hung Chen, Shan-Shar City (TW); Ping-Hsu Chen, Dongshih Township (TW); Chih-Tien Chang, Hsinchu City (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/636,154

(22) Filed: Aug. 7, 2003

(51) Int. Cl. G06F 9/45; H05H 1/24

(52) U.S. Cl. 427/569; 118/715

(57) ABSTRACT

Uniform spatial distribution of plasma over the face of a semiconductor wafer is achieved using a multi-zone electrode forming part of an electrostatic chuck used to hold the wafer in a processing chamber. The electrode includes a plurality of concentric electrode portions to which differing RF bias voltages may be applied to produce an electric field having a desired spatial distribution. Sensors are used to monitor either the spatial distribution of the plasma or the process effects of the plasma, and the sensed information is fed back to a controller that adjusts the bias voltage on the electrode portions in a manner to maintain the spatial uniformity of the plasma.

### TECHNICAL FIELD

The present invention broadly relates to methods and apparatus for generating plasmas used to manufacture semiconductor devices, and deals more particularly with a technique for controlling the spatial distribution of RF power used to generate the plasma.

### BACKGROUND OF THE INVENTION

In processing semiconductor wafers used to form integrated circuits, plasma-assisted processes are frequently used for both depositing materials onto the wafer and for etching materials from the wafer surface. Such processes include plasma etching, reactive ion etching (RIE), plasma enhanced chemical vapor deposition (PECVD), as well as a number of other well-known processes. In order to generate the plasma, an RF (radio frequency) power source is used to power to one or more electrodes within a vacuum vessel containing a gas at a predetermined pressure in which the processing is to take place. A matching network is typically used to efficiently couple power from the RF power source to the powered electrodes.

The creation of an electrical field between electrodes within the vacuum chamber causes electrons present in the gas to initially collide elastically within gas molecules. As this process continues, the electron gain more energy and eventually begin to collide inelastically with the gas molecules to form the excited or ionized species. Eventually, a steady state plasma is formed in which the excitation and recombination of the atoms with electrons within the plasma are balanced. Highly reactive ions and radical species are produced in the plasma and may be used to etch or deposit materials on semiconductor wafers. Electric and magnetic fields form within the vacuum chamber either by action of plasma or by external application of magnetic fields and/or DC or RF self-induced biasing mechanisms are used to control the etching and deposition processes within the vacuum chamber. Although the electrodes used to produce the electric fields creating the plasma may be discrete elements within the processing chamber, a more common and efficient arrangement typically used in the industry integrates one of the electrodes with a pedestal or clamping device used to hold the wafer in the processing chamber. Most frequently, the electrode is integrated into an assembly containing an electrostatic chuck (ESC) used to hold the wafer on a pedestal by means of an electrostatic force. In an ESC, a voltage difference is applied to two electrodes abutting and separated by a dielectric material. This applied voltage causes charges of a first type within the dielectric to be attracted to one electrode and charges of the opposite type to be attracted to the other electrode. This creates a voltage gradient within the dielectric material. Surface charges on the semiconductor wafer abutting the dielectric are affected by this gradient, causing the wafer to be clamped to the ESC due to the attractive forces between the differently charged surfaces.

In a so called unipolar ESC, a voltage is applied across the dielectric material separating the metallic electrode from the wafer. In such case, the wafer acts as the second electrode, which, along with the dielectric and a metallic electrode, forms a parallel capacitor. The attractive force created by the difference in potential of the charges on the two electrodes clamps the wafer to the ESC.

In bipolar ESCs, the wafer does not serve as a electrode. Instead, a voltage difference is applied across two other electrodes spaced apart from each other and separated from the wafer by one or more layers of dielectric insulators or semiconductor material. The voltage differences induces charges on the backside of the wafer, thus attracting the wafer to the ESC.

In both unipolar and bipolar ESCs, the plasma is created by applying a high voltage RF signal to the electrostatic chuck. As a result, a bias voltage, typically on the order of several hundred volts, develops on the wafer.

When processing semiconductor wafers using a plasma, it is normally desirable to achieve uniform processing over the entire surface of the wafer. Unfortunately, however, the density distribution of the plasma is often not uniform over the wafer, but instead varies as a result of a number of factors, such as non uniform heating of the wafer, variations in the physical geometry of the chamber which in turn affects distribution of the plasma within the chamber, and variations in the electrical field producing the plasma due to non-uniformity of the RF bias potential over the face of the wafer. As a result of such variations, deposition and/or etch rates vary over the wafer in a manner that may not always be predicted, and where predictable, require that additional measures be taken to compensate for the variations.

Accordingly, there is a need in the art for a method and apparatus which produces a plasma over the face of the wafer that has uniform density to allow repeatable and consistent processing of wafers. The present invention is directed toward satisfying this need.

### SUMMARY OF THE INVENTION

According to one aspect of the invention, a method is provided for controlling the spatial distribution of RF power used to generate a plasma for processing a semiconductor device, comprising the steps of producing RF power, delivering the RF power to each of a plurality of separate electrode zones, and separately controlling the power to each of the electrode zones so as to produce a desired spatial distribution of RF power in the area of the semiconductor device. The RF power delivered to the electrode zones is preferably controlled by tuning each of a plurality of variable capacitors that capacitively couple the RF power from a source to the electrode zones. The electrode zones are preferably formed by providing a plurality of concentric electrodes on an electrostatic chuck used to hold the semiconductor device during processing. In a preferred embodiment, means are provided for sensing the spatial distribution of RF power in a processing chamber and a control system is provided for altering the amount of RF power delivered to each of the electrode zones so as to maintain a desired spatial distribution of the RF power.

In accordance with another aspect of the invention, apparatus is provided for generating an RF power field used to produce a plasma, comprising an RF power generator, an electrode having a plurality of separate electrode portions, and a circuit for connecting the generator with the electrode and separately controlling the amount of RF power delivered from the generator to each of the electrode portions. The control circuit preferably includes a capacitor network for capacitively coupling the electrode portions with the RF generator. The capacitor network includes a plurality of individually tunable capacitors respectively associated with the electrode portions and controllable to capacitively couple the desired amount of RF power to the associated electrode portions. In a preferred embodiment, the electrode portions are concentric ring electrodes.

Accordingly, it is the primary object of the present invention to provide a method and apparatus for generating a processing plasma using RF power in which the plasma density is uniform across the entire surface of the semiconductor wafer being processed.

Another object of the invention is to provide a method and apparatus as mentioned above which controls the RF power used to generate the plasma in a manner that achieves uniformity of the RF electric field over the entire face of the semiconductor wafer.

Another object of the invention is to provide a method and apparatus of the type described above in which an electrode used to generate an RF electrical field is integrated into an electrostatic chuck and includes separate electrode portions that are individually controllable.

A still further object of the invention is to provide a method and apparatus of the type generally described above that is capable of sensing non-uniformity in the plasma density over the wafer and taking corrective action to eliminate the nonuniformity.

These, and further objects and advantages of the present invention will be made clear or will become apparent during the course of the following description of a preferred embodiment of the invention.

### BRIEF DESCRIPTION OF THE DRAWINGS

In the drawings which form an integral part of the specification and are to be read in conjunction therewith, and in which like reference numerals are employed to designate identical components in the various views:

FIG. 1 is a combined diagrammatic and block diagram of a prior art, monopole electrostatic chuck coupled with an RF power source;

FIG. 2 is a plot of the plasma density over the face of the wafer held by the ESC FIG. 1;

FIG. 3 is a plot showing the change in the voltage applied to the ESC in FIG. 1 as a function of time;

FIG. 4 is a combined block and dramatic view of apparatus for generating a plasma having uniform density, forming the preferred embodiment of the invention;

FIG. 5 is a view similar to FIG. 4 but showing the circuit elements in more detail;

FIG. 6 is a plan view of the electrode assembly used in the apparatus shown in FIG. 4;

FIG. 7 is a plot showing the plasma density over the face of the wafer that is produced using the apparatus of FIG. 4; and, FIG. 8 is a plot showing the change in voltage applied to the ESC of FIG. 4 as a function of time.

### DESCRIPTION OF THE PREFERRED EMBODIMENT

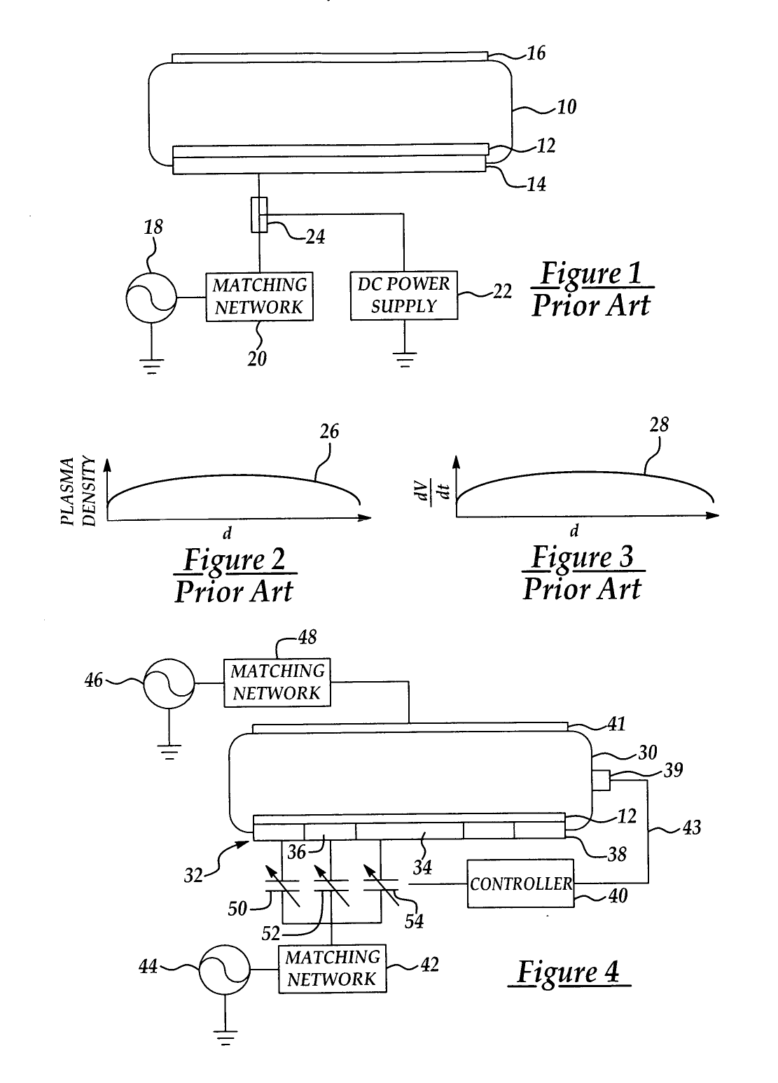

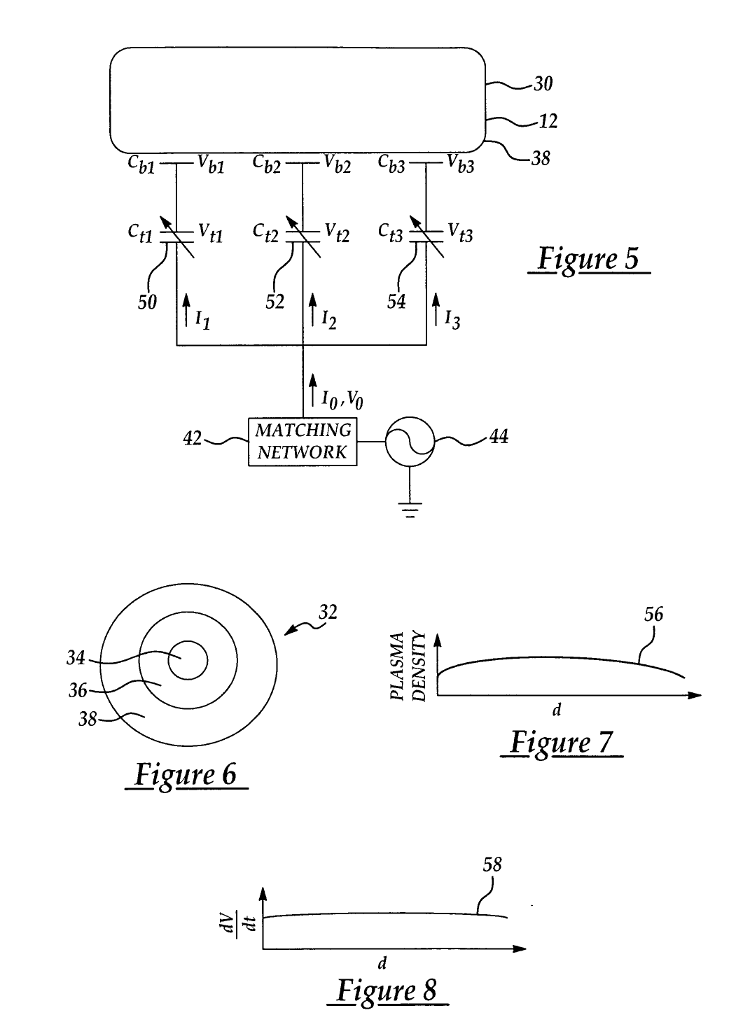

Referring first to FIG. 1, a conventional prior art, monopole ESC is depicted comprising a plate 14 for holding a semiconductor wafer 12 thereon within a processing chamber 10. The ESC plate 14 is connected to a DC power supply 22 using a DC/RF coupler 24. The wafer 12 is separated from the plate 14 by a thin layer of a dielectric (not shown). The DC power supply 22 charges the plate 14 which causes charge separation on the bottom surface of the wafer 12, resulting in the latter being attracted to and clamped to the plate 14. An RF electric field is created within the chamber 10 using a RF power source 18 which delivers RF power through a matching network 20 and the DC/RF coupler 24 to plate 14 which acts as a first electrode. The alternating voltage applied by the RF power source to the first electrode plate 14 is known as the RF bias voltage. A second electrode 16 cooperates with the electrode plate 14 to produce an electric field over the upper surface of the wafer 12 within the chamber 10. As previously described, this RF electric field produces a plasma within the chamber 10 adjacent to and covering the upper face of the wafer 12. Due to a number of factors, including the physical configuration of the chamber 10, corrosion resistance, cooling characteristics and chucking force, the plasma created across the face of the wafer 14 may not have an even distribution, but rather, as shown by the plot 26 in FIG. 2, is lower in magnitude near the edges of the wafer 12, and is greater toward the center of the wafer. The non-uniformity of the plasma density over the face of the wafer 12 is related to the fact that the change of the RF bias voltage applied to the electrode plate 14 is not constant over the face of the plate 14. This can be seen from FIG. 3, wherein the curve plot 28 represents the change of the RF bias voltage applied to the prior art electrode 14 as a function of time, i.e. dV/dT, varies over the distance “d” across the face of the plate. As a result of these non-uniformities, the processing results e.g. deposition or etch rate, over the face of the wafer are likewise nonuniform. In some cases, it may be possible to partially compensate for these process variations, but such compensation, even where possible, will require trial and error, resulting in scrap and reduction of throughput. In other cases, it may be impossible to compensate for the process variations.

According to the present mention, the undesired processing variations can be substantially reduced or, in some cases, eliminated using a novel method and the apparatus shown in FIG. 4. In accordance with the present invention, a novel ECS plate 32 is formed with three separate electrode portions or zones, 34, 36, 38 which are concentric and insulated from each other. This insulated relationship may be created by separating the electrodes portions 34-38 from each other by an insulating dielectric, or by simply spacing the electrode portion from each other. A greater or lesser number of electrode portions may be employed, if desired, depending upon the application. Also, the electrode portions 34, 36, 38 need not be concentric, but may possess other geometries. What is significant however, is that electrode portions are separated from each other and are positioned relative to each other such that they can create a desired, spatial profile of the RF electric field to be generated within the chamber 30.

RF energy created by a first RF power source 14 is conditioned by a matching network 42 and capacitively coupled to the electrode plate 32 by means of variable capacitors 50, 52, 54 which are respectively related to and connected with electrode portion 34, 36, 38. The matching network 42 functions to minimize the reflection of RF power back from the processing chamber 30 which would otherwise reduce the efficiency of the generated plasma. Such power reflection is generally caused by a mismatch in the impedance of the RF power source 44 and a load which is formed by the combination of the ESC and the plasma generated within the chamber 30.

The variable capacitors 50, 52, 54 are individually controllable or tunable by a controller 40 which functions to individually adjust the capacitors 50, 52, 54 in order to achieve a desired spatial distribution of the plasma generated within the chamber 30. Control of the spatial distribution of the plasma is achieved by controlling of the RF bias voltage that is coupled by each of the capacitors 50, 52 and 54 to the respective electrode portions 34, 36, 38. For example, if it is known that the plasma density has a tendency to be lower near the outer edge of the wafer 12, then the capacitor 50 is adjusted by controller 40 so as to slightly increase the RF bias voltage applied to the outer electrode portion 38. Similarly, capacitor 52 would be tuned by the controller 40 so as to reduce the RF bias voltage applied to electrode portion 34, which in turn would reduce the RF electric field, and thus the plasma density, near the center of the wafer 12.

According to the present invention, a feedback system may be employed to provide real-time, dynamic control of the spatial distribution of the plasma generated within the chamber 30. This control is carried out by monitoring the plasma density, as by means of an appropriate sensor 39 at each of a plurality of locations within the chamber 30, or by monitoring the effects of processing, such as etch rates at each of a plurality of locations on the wafer 12. This dynamic information is fed back on line 43 to the controller 40 which then assesses the need to make changes in the spatial distribution of the plasma, and if any changes are necessary, adjust the tuning of the capacitor 50, 52, 54 so as to alter the RF electric field in a manner that effects a corresponding change in the spatial distribution of the plasma density.

A second electrode 41 is provided near the top of the chamber 40. Electrode 41 is connected through a second matching network 48 to a second RF power source 46. One of the RF power generators 44, 46 may be of a lower frequency, and the other of a higher frequency. Each frequency causes different physical phenomena in the plasma. For example a lower frequency excitation causes direct acceleration of the electrons and ions. This results in higher energy ions and a higher plasma potential. A high frequency excitation leads to the formation of a plasma having a lower potential then when excited by a low frequency signal of similar power levels. Dual frequency systems thus permit higher ion densities in the plasma which result in a higher ion flux into the wafer while permitting the sheath potential at the wafer to be independently controlled by the bias RF power supply 44. This significantly affects the etch rate—a higher density of ion flux into the wafer will usually result in a higher etch rate.

C_{b1}, C_{b2} and C_{b3} depend on the condition of the plasma and the size and configuration of the specific hardware that is employed in a particular application. Tuning Cₜ₁, Cₜ₂ and Cₜ₃ optimizes the bias voltages V_{b1}, V_{b2} and V_{b3}, as well as currents I₁, I₂ and I₃.

Attention is now directed to FIG. 7, wherein the curve plot 56 represents the density of the plasma across the face of the wafer 12 using the novel apparatus of the present invention. The use of the novel electrode plate 32 in combination with the tunable capacitors 50, 52, 54 can be seen to result in a flatter, more uniform density curve 56, compared to the density curve 26 shown in FIG. 2. This more uniform plasma density which is generated over the face of the wafer 12 is the result of the fact that the RF bias voltage is adjusted over the face of the wafer 12 so as to produce an RF electric field that is spatially uniform. This can be better seen by reference to FIG. 8 which shows that the change of the RF bias voltage applied to the electrode 32 as a function of time is essentially flat or uniform over the diameter “d” of the wafer 12.

From the foregoing, it is apparent that the method and apparatus for controlling spatial distribution of RF power and plasma density described above not only provides for the reliable accomplishment of the objects of the invention, but does so in a particularly simple and economic manner. It is recognized, of course, that those skilled in the art may make various modifications or additions to the preferred embodiment chosen to illustrate the invention without departing from the spirit and scope of the present contribution to the art. Accordingly, it is to be understood that the protection sought and to be afforded hereby should be deemed to extend to the subject matter claimed and all equivalents thereof fairly within the scope of the invention.

1. A method of controlling the spatial distribution of RF power used to generate a plasma for processing a semiconductor device, comprising the steps of:
(a) producing RF power;
(b) delivering the RF power to each of a plurality of separate electrode zones; and
(c) separately controlling the power delivered to each of the electrode zones so as to produce a desired spatial distribution of RF power in the area of the semiconductor device.

2. The method of claim 1, wherein step (c) is performed by tuning each of a plurality of electrical circuits respectively associated with the zones.

3. The method of claim 2, wherein step (b) includes capacitively coupling the power generated in step (a) to each of the zones.

4. The method of claim 3, wherein step (c) includes tuning each of the capacitors used to couple the power to the zones.

5. The method of claim 1, including the step of forming the electrode zones by providing a plurality of electrodes on a chuck for holding the semiconductor device during processing.

6. The method of claim 1, wherein step (a) is performed using a single source of RF power.

7. The method of claim 1, including sensing the spatial distribution of RF power in a chamber used to process the semiconductor device, and wherein the RF power delivered in step (b) is controlled based on the sensed distribution.

8. The method of claim 1, including electrically matching the RF power produced in step (a) with a network used to deliver the RF power in step (b).

9. The method of claim 1, including arranging a plurality of electrodes on an chuck used to hold the semiconductor device, and capacitively coupling the electrodes to an RF power source.

10. Apparatus for generating an RF power field used to produce a plasma, comprising:
an RF power generator;
an electrode having a plurality of separate electrode portions; and,
a circuit for connecting the generator with the electrode and for separately controlling the amount of RF power delivered from the generator to each of the electrode portions.

11. The apparatus of claim 10, wherein the circuit includes a capacitor network for capacitively coupling the electrode portions with the RF generator.

12. The apparatus of claim 11, including a matching network for electrically matching the RF generator with the capacitor network.

13. The apparatus of claim 11, wherein the capacitor network includes a plurality of variable capacitors each capacitively coupling the electrode portions with the RF generator.

14. The apparatus of claim 13, wherein the connecting circuit includes a controller for tuning each of the capacitors.

15. The mask of claim 13, wherein the electrode portions are concentric ring electrodes.

16. The apparatus of claim 15, wherein the variable capacitors are respective coupled with the ring electrodes and are operable to capacitively couple RF power from the generator to the ring electrodes.

17. The apparatus of claim 16, wherein the connecting circuit includes a controller for tuning the variable capacitors and thereby control the amount of power coupled top each of the ring electrodes.

18. The apparatus of claim 10, including a sensor for sensing information related to the spatial distribution of the plasma and for delivering the sensed information to the controller.

19. The apparatus of claim 19, wherein the controller includes means for changing the RF power delivered to at least certain of the electrode portions based on the information delivered to the controller by the sensor.
